(19) United States
(12) Patent Application Publication
(10) Pub. No.: US 2012/0250055 A1
(43) Pub. Date: Oct. 4, 2012

(54) IMAGE PROCESSING APPARATUS, IMAGE FORMING APPARATUS, IMAGE PROCESSING METHOD, IMAGE PROCESSING PROGRAM, AND STORAGE MEDIUM

(75) Inventor: Takeshi Nakamura, Kanagawa (JP)

(73) Assignee: RICOH COMPANY, LTD., Tokyo (JP)

(21) Appl. No.: 13/414,784

(22) Filed: Mar. 8, 2012

(30) Foreign Application Priority Data
Mar. 30, 2011 (JP) 2011-074040

(51) Int. Cl. G06F 3/12; G06K 15/02

(52) U.S. Cl. 358/1.13; 358/1.16; 358/1.15

(57) ABSTRACT

An image processing apparatus includes a receiving unit to receive imaging processing information indicating how to process raw image data; a storage interface, to which an external storage device is detachably attachable, to access data stored in the external storage device; and a storage controller to store the raw image data and the imaging processing information to the external storage. The raw image data is data unprocessed by an image processing operation conductable using the imaging processing information used as tuning data for processing the raw image data.

### CROSS-REFERENCE TO RELATED APPLICATION

This application claims priority to Japanese Patent Application No. 2011-074040, filed on Mar. 30, 2011 in the Japan Patent Office, which is incorporated by reference herein in its entirety.

### BACKGROUND

1. Technical Field

The present invention relates to an image processing apparatus, an image forming apparatus, an image processing method, an image processing program, and a storage medium, and more particularly to an image processing apparatus, an image forming apparatus, an image processing method, an image processing program, and a storage medium to designate a given image processing of image processing contents such as image data and to conduct the given image processing using other image processing apparatuses and/or image forming apparatuses.

2. Description of the Background Art

Image processing apparatuses such as printers, copiers, facsimile machines, and multi-functional apparatuses typically include a control panel operable by a user. The user operates the control panel to input various settings for an image processing operation, designating image processing contents so that the image processing apparatus can output an image of the desired quality. For example, such settings may relate to the state of the document, such as the document type or image density, or they may relate to image processing, such as enlargement/reduction of the image, single-sided/duplex printing, the size of the margins, etc., as well as post-processing operations such as sorting, stapling, and hole punching.

Conventional image processing apparatuses are configured to include a large number of functions with multiple settings for each function to enable the user to set all the various items described above. As a result, however, the user must select the desired settings from an enormous number of possibilities, which is not a user-friendly operation.

To enhance the user-friendliness of such image processing selection, conventional apparatuses may use setting history. For example, JP-2010-62755-A discloses a configuration in which past processing contents or user instructions are stored and a display unit displays setting information based on that stored information. Then, a user can set the desired settings for an image processing operation by selecting one or more items from the displayed information.

Further, the above mentioned technology used for image processing settings can be used with other technologies that store image data to an external memory, in which image data accumulated in a storage device such as a hard disk drive can be processed based on settings of image processing operation input from the control panel, and then the processed image data can be stored in the external memory. In this case, only the processed image data is stored in the external memory.

The external memory storing the processed image data can be removed from one image processing apparatus and attached to another image processing apparatus. In the conventional art, when an external memory is to be used with other image processing apparatus, because the external memory holds only the processed image data, such image data may be required to be processed by image processing suitable for such other image processing apparatus, in which, for example, the control panel of such other image processing apparatus may be used for inputting image processing conditions. For example, when the external memory is used with a printer, a printing operation can be conducted after processing the image data in a way suitable for that particular printer.

However, such image adjustment cannot be conducted by some image processing apparatuses such as low-cost printers or the like that do not have a control panel, for example. Consequently, the image data stored in the external memory cannot be processed with the image processing contents designated by the image processing apparatus that processes the image data and stores the processed image data to the external memory.

### SUMMARY

In one aspect of the present invention, an image processing apparatus is devised. The image processing apparatus includes a receiving unit to receive imaging processing information indicating how to process raw image data; a storage interface, to which an external storage device is detachably attachable, to access data stored in the external storage device; and a storage controller to store the raw image data and the imaging processing information to the external storage. The raw image data is data unprocessed by an image processing operation conductable using the imaging processing information used as tuning data for processing the raw image data.

In another aspect of the present invention, an image forming apparatus is devised. The image forming apparatus includes an image processing unit to process raw image data based on imaging processing information designating how to process the raw image data, and to generate processed image data; a storage interface, to which an external storage device is detachably attachable, to access data in the external storage device; an image forming unit, having a given engine characteristic for forming images, to form an image on a recording medium based on the processed image data; and a storage controller to store the raw image data and the imaging processing information to the external storage device. The raw image data is unprocessed by an image processing operation conductable using the imaging processing information used as tuning data for processing the raw image data.

In another aspect of the present invention, a non-transitory computer readable carrier medium storing a program that, when executed by a computer, causes the computer to execute a method of controlling image processing by an image forming apparatus is devised. The method includes the steps of receiving imaging processing information indicating how to process raw image data; accessing data in an external storage device detachably attachable to the image forming apparatus; and storing the raw image data and the imaging processing information to the external storage device. The raw image data is data unprocessed by an image processing operation conductable using the imaging processing information used as tuning data for processing the raw image data.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram of an image forming apparatus according to an example embodiment;

FIG. 2 is a functional block diagram of a controller;

FIG. 3 is a flow chart showing steps of a basic printing process;

FIG. 4 is a flow chart showing steps of a process of accumulating print data;

FIG. 5 is an example of an accumulated data list screen;

FIG. 6 is an example of an image adjustment menu;

FIG. 7 is an example of a brightness adjustment screen;

FIG. 8 is an example of a color-condition adjustment screen;

FIG. 9 is a schematic data structure of image data and tuning data tied and stored in an external storage;

FIG. 10 is a flow chart showing steps of an image adjustment/printing process;

FIG. 11 shows a difference of engine characteristic parameter included in tuning data and engine characteristic parameter of printer engine that executes a printing process; and

FIG. 12 is an example of a confirmation screen.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, an apparatus or system according to example embodiment is described hereinafter.

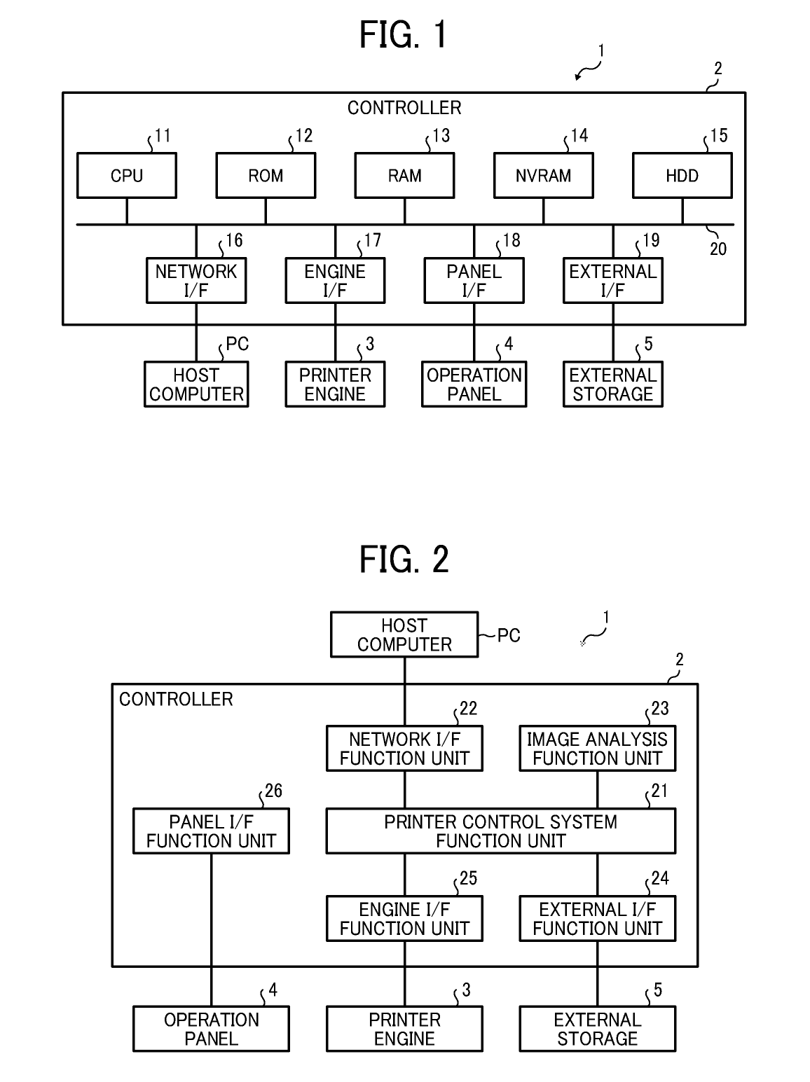

FIGS. 1 to 12 show an image forming apparatus, an image forming control method, a software program of image forming control method, and a carrier medium according to an example embodiment. The carrier medium may be also referred to as a storage medium. FIG. 1 is a block diagram of an image forming apparatus 1, which employs an image forming apparatus, an image forming control method, a software program storing program code for executing an image forming control method, and a carrier medium according to an example embodiment. The image forming apparatus 1 is described as one example of image processing apparatuses or information processing apparatuses.

As shown in FIG. 1, the image forming apparatus 1 includes a controller 2, a printer engine 3, and a control panel 4 or operation panel 4, and an external storage 5. The controller 2 includes a central processing unit (CPU) 11, a read only memory (ROM) 12 such as a program ROM, a random access memory (RAM) 13, a nonvolatile random access memory (NVRAM) 14, a hard disk drive (HDD) 15, a network interface (UF) 16, an engine interface (UF) 17, a panel interface (UF) 18, and an external interface (UF) 19, wherein such units can be connected with each other using a bus 20.

The network OF 16 can be connected to a host computer Pc via a network such as a local area network (LAN) or the like. The network OF 16 receives control signal and data (e.g., print data) from the host computer Pc, and transmits status signal or the like from the image forming apparatus 1 to the host computer Pc. As such, the network OF 16 can be used as an interface.

The ROM 12 such as a program ROM stores various types of software programs such as a program for data processing/management in the controller 2 and a program for controlling peripheral modules, and various types of data to execute each software program. Specifically, the ROM 12 stores one or more software programs for basic processing in the image forming apparatus 1, and software programs for processing data such as an image processing program used for storing image data and tuning data to the external storage 5, and various types of data to execute each software program.

The CPU 11 can execute each software program stored in the ROM 12 while using the RAM 13 as a working memory. Specifically, the CPU 11 controls each unit in the image forming apparatus 1 to conduct a printing process, and controls an image processing method, which will be described later.

The RAM 13 can be used as a working memory of the CPU 11, and as a buffer to temporarily store page-by-page data converted from print data transmitted from the host computer Pc, and a bitmap memory to store image drawing data (i.e., actual print data) converted from data stored in the buffer. The RAM 13 has a capacity sufficient to store the print data, the image drawing data converted from the print data, or intermediary data for a plurality of pages.

The NVRAM 14 is a memory to store data even when the power supply to the image forming apparatus 1 is shut off, and stores data that needs to be retained when power supply to the image forming apparatus 1 is shut off. For example, under the control of the CPU 11, the NVRAM 14 stores various setting information such as system setting values, count values of printed sheets, print-settings values, and engine parameters indicating engine characteristics of the printer engine 3, such as red color output becomes relatively dark.

The hard disk drive 15 stores print data loaded for the image forming apparatus 1, data (e.g., print data) transmitted from the host computer Pc under the control of the CPU 11. Such data can be read out as required. The hard disk drive 15 stores print data transmitted from the host computer Pc. Such data can be used for confidential printing and reservation or time-shift printing when a print request is input by a user using the user identification (ID).

The engine OF 17 can be connected to the printer engine 3. The engine OF 17 is used to transmit control signals and image drawing data from the controller 2 to the printer engine 3, and to transmit status signals from the printer engine 3 to the controller 2.

The printer engine 3, used as an image forming unit, for example, can be used as a printer engine of an electro-photographic printer, inkjet printer, or the like. Print data is transmitted from the host computer Pc via the network OF 16, and is converted to image drawing data, and then the image drawing data is received by the printer engine 3 via the engine OF 17. Based on the image drawing data and control signals from the engine OF 17, the printer engine 3 prints an image on a sheet, fed from a sheet feeder (i.e., outputting process of image), and ejects the printed sheet to an ejection tray through a sheet ejection port.

When the printer engine 3 employs an electro-photographic engine, the printer engine 3 includes a photoconductor, a charging unit, an optical writing unit, a developing unit, a transfer unit, and a cleaning unit, which may be required for electrophotography printing process to print an image on a sheet based on image drawing data. A latent image can be formed on the photoconductor using the optical writing unit based on image drawing data and control signals, and then a toner image can be formed on the photoconductor by supplying toner onto the latent image using the developing unit. Under the control of the printer engine 3, a sheet is fed between the photoconductor and a transfer unit from a sheet feeder, and then the toner image is transferred from the photoconductor to the sheet. The sheet having the transferred toner image is then transported to a fixing unit to fix the toner image on the sheet by applying pressure and heat, by which a printing process completes.

The panel OF 18 can be connected to the operation panel 4 or control panel 4. The panel OF 18 can be used to transmit signals or data between the controller 2, including the CPU 11, and the operation panel 4. The panel OF 18 can be used as a receiving unit that receives information input through the operation panel 4 or the like.

The operation panel 4 or control panel 4 may include operation keys such as ten keys, a start key, mode keys to select modes, and a display such as a touch panel display using a liquid crystal display (LCD). By operating the operation keys and touching the display, various instructions such as print instruction can be input, and the display displays instructions input from the operation keys, and other information of the image forming apparatus 1 to report information and status of the image forming apparatus 1 to a user. As such, the control panel 4 can be used as an information input unit and a display unit.

The external OF 19 can be connected to the external storage 5, which may be a detachable and portable storage. The external storage 5 may be, for example, a universal serial bus (USB) memory, a memory card such as secure digital (SD) memory card, and a floppy disk (registered trademark), but not limited thereto. Under the control of the CPU 11, the external OF 19 drives the external storage 5 to read out data stored in the external storage 5, and to write data to the external storage 5. The external OF 19 can automatically detect an insertion and removal of the external storage 5 to the external OF 19, and outputs a detection result to the CPU 11. As such, the external OF 19 can be used as a storage interface, and the external OF 19 can be also used as a storage controller, wherein the CPU 11 may function as the storage controller with the external OF 19.

The host computer Pc, connectable to the network OF 16, may be a personal computer (PC) having a hardware configuration or a hardware/software-combined configuration. The host computer Pc can transmit print data prepared by page description language (PDL) and control command such as print control data prepared by printer job language (PJL) to the image forming apparatus 1. The host computer Pc may use a printer driver to generate or prepare print data composed of PJL data and PDL data, and transmits the print data to the image forming apparatus 1 via a network.

As for the image forming apparatus 1, a software program to implement an image processing according an example embodiment can be loaded to the ROM 12.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device.

The computer software can be provided to the programmable device using any storage medium for storing processor readable code such as a flexible disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, work station) may control an information processing apparatus or an image processing apparatus such as image forming apparatus using a computer-readable program, which can execute the above-described processes or steps. In the above described embodiments, at least one or more of the units of apparatus can be implemented in hardware or as a combination of hardware/software combination. In example embodiment, processing units, computing units, or controllers can be configured with using various types of processors, circuits, or the like such as a programmed processor, a circuit, an application specific integrated circuit (ASIC), used singly or in combination.

When a program for implementing an image processing is loaded and executed in the image forming apparatus 1, the controller 2 can be configured with functional units as shown in FIG. 2. For example, the controller 2 is configured with a printer control system function unit 21, a network interface (UF) function unit 22, an image analysis function unit 23, an external interface (UF) function unit 24, an engine interface (UF) function unit 25, and a panel interface (UF) function unit 26. The image analysis function unit 23 may be referred to as a PDL/PostScript/PCL/RPCS function unit 23.

The network OF function unit 22, devised as the network OF 16, receives control signals and data (e.g., print data) from the host computer Pc, and then transmits the signals and data to the printer control system function unit 21. Further, the network OF function unit 22 receives status signals from the printer control system function unit 21 of the image forming apparatus 1 and then transmits the status signals to the host computer Pc.

The image analysis function unit 23, used as an image processing unit, may be devised by the CPU 11. The image analysis function unit 23 receives print data and generates or prepares image drawing data, and stores the image drawing data to the RAM 13 and/or HDD 15. As such, the image analysis function unit 23 can be used as a generator of image drawing data (image drawing data generator). Further, in response to a request from the printer control system function unit 21, the image analysis function unit 23 reads out image drawing data from the RAM 13 and/or HDD 15, and transfers the image drawing data to the printer control system function unit 21. Specifically, the image analysis function unit 23 interprets PJL command and PDL command in the print data transmitted from the host computer Pc to generate or prepare image drawing data, and then the image analysis function unit 23 transfers the image drawing data and print-settings information (e.g., information designating how to process image data) to the printer control system function unit 21.

The external OF function unit 24, devised as the external OF 19, is used to store the image drawing data and print-settings (e.g., information how to process image data), received from the printer control system function unit 21, to the external storage 5 under the control of the printer control system function unit 21. Further, the external OF function unit 24 is used to read out the image drawing data and print-settings stored in the external storage 5, and transfers the image drawing data and print-settings to the printer control system function unit 21.

The panel OF function unit 26 may be devised as the panel OF 18. Under the control of the printer control system function unit 21, the panel OF function unit 26 controls the operation panel 4. Accordingly, the panel OF function unit 26 can be used as the receiving unit that receives information input through the operation panel 4 or the like.

The engine OF function unit 25 may be devised as the engine OF 17. Under the control of the printer control system function unit 21, the engine OF function unit 25 issues a print instruction or other instructions to the printer engine 3.

The printer control system function unit 21, which may be devised by the CPU 11, controls each unit in the image forming apparatus 1, and operations of the printer engine 3. For example, the printer control system function unit 21 can transfer image drawing data and print-settings, processed by the image analysis function unit 23, to the printer engine 3 via the engine OF function unit 25. Further, the printer control system function unit 21 can store image data before receiving an image processing to the external storage 5 via the external OF function unit 24. For the simplicity of explanation in this disclosure, such image data before receiving the image processing may be referred to as print data, image drawing data, or raw image data.

The printer control system function unit 21 may function as an image processing control unit to instruct the image analysis function unit 23 used as the image processing unit to conduct an image processing based on imaging processing information input through the operation panel 4 used as the input unit, and to display an image corresponding to the processed image data on the display unit.

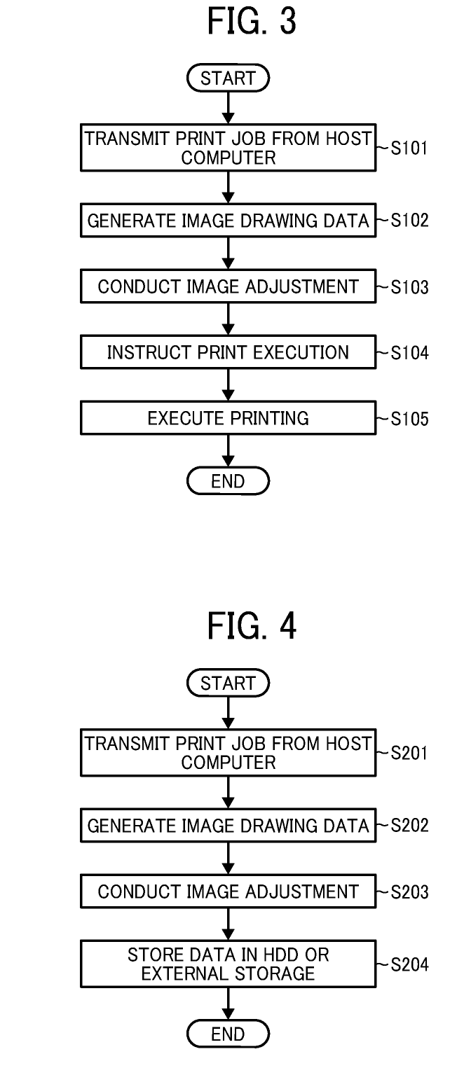

A description is given of processing using the image forming apparatus 1. As for the mage forming apparatus 1, raw image data and tuning data are stored in the external storage 5. The tuning data may include imaging processing information designating how to process the raw image data. Such raw image data can be processed by other image processing apparatus effectively and efficiently using the designated imaging processing information. At first, a basic printing process for print job including print data and print settings, transmitted from the host computer Pc, is described with reference to FIG. 3.

When a print job including print data and print-settings is transmitted from the host computer Pc to the image forming apparatus 1 (step S101), the network OF function unit 22 receives the print job, and transfers the print job to the printer control system function unit 21. Then, the printer control system function unit 21 instructs the image analysis function unit 23 to analyze PDL, PCL, or the like included in the print job.

If an analysis result by the image analysis function unit 23 indicates a print execution, the printer control system function unit 21 generates or prepares image drawing data from the print data included in the print job based on the analysis result, in which the image drawing data can be generated by processing the print data based on the print-settings included in the print job, and converting the print data to the image drawing data that can be printed by the printer engine 3 (step S102). Then, an image adjustment is conducted based on information input from the operation panel 4 (step S103).

Upon completing the image adjustment of image drawing data, the printer control system function unit 21 transmits the adjustment-completed image drawing data and the print execution instruction to the printer engine 3 via the engine OF function unit 25 (step S104), and instructs the printer engine 3 to execute a printing process (step S105).

Further, as for the image forming apparatus 1, the image drawing data, prepared by converting the print data included in the print job transmitted from the host computer Pc, can be stored in a storage medium such as HDD 15, external storage 5, or the like. Such print data accumulation processing is described with reference to FIG. 4.

As shown in FIG. 4, when a print job including print data and print-settings are transmitted from the host computer Pc to the image forming apparatus 1 (step S201), the network OF function unit 22 receives the print job, and transfers the print job to the printer control system function unit 21. Then, the printer control system function unit 21 instructs the image analysis function unit 23 to analyze PDL, PCL, or the like included in the print job.

If an analysis result by the image analysis function unit 23 indicates an accumulation of data, the printer control system function unit 21 generates or prepares image drawing data from the print data included in the print job based on the analysis result, in which the image drawing data can be generated by processing the print data based on the print-settings included in the print job, and converting the print data to the image drawing data that can be printed by the printer engine 3 (step S202). Then, an image adjustment is conducted for the image drawing data based information input from the operation panel 4 (step S203).

Upon completing the image adjustment of image drawing data, the printer control system function unit 21 stores the adjustment-completed image drawing data and image setting instruction information, which may be referred to as imaging processing information, to a storage such as HDD 15, or transmits and stores the adjustment-completed image drawing data and imaging processing information to a storage such as external storage 5 via the external OF function unit 24 (step S204).

Further, as for the image forming apparatus 1, an image adjustment processing to the image data stored in the HDD 15 or the external storage 5 can be conducted by operating the operation panel 4, in which an image adjustment processing based on instructions designated through the operation panel 4 is conducted.

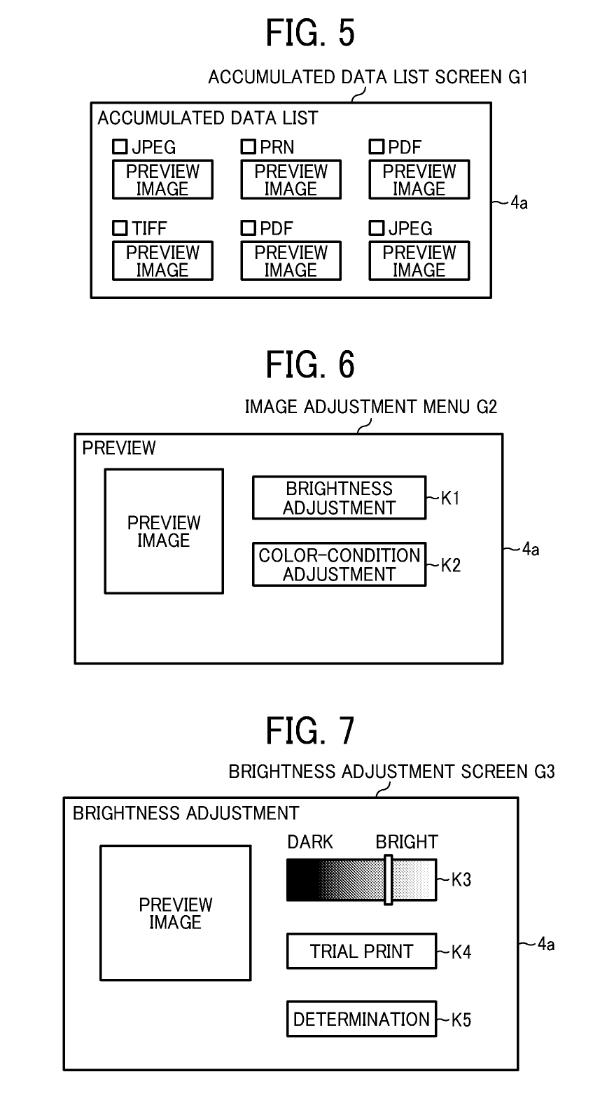

When the adjustment of images is conducted using the image forming apparatus 1, an image processing mode can be selected by operating the operation panel 4, in which an accumulated data list screen G1 shown in FIG. 5 may be displayed on a display of the operation panel 4. The printer control system function unit 21 generates or prepares a preview image of image data (e.g., image drawing data) accumulated in a storage medium such as HDD 15, external storage 5, or the like, and instructs the operation panel 4 to display the preview image on the display area 4a via the panel OF function unit 26.

When a target image or process-target image, which is to be processed, is selected from the accumulated data list screen G1, the printer control system function unit 21 displays an image adjustment menu G2 shown in FIG. 6 on the display area 4a of the operation panel 4. As shown in FIG. 6, the printer control system function unit 21 displays a preview image of process-target image and an image adjustment item on the image adjustment menu G2. For example, the image adjustment item may be brightness adjustment and color-condition adjustment, and the image adjustment menu G2 displays a brightness adjustment key K1 and a color-condition adjustment key K2.

When the brightness adjustment key K1 is touched on the image adjustment menu G2, the printer control system function unit 21 shifts the image adjustment menu G2 to a brightness adjustment screen G3 on the display area 4a of the operation panel 4 as shown in FIG. 7. For example, the brightness adjustment screen G3 includes a preview image area, a brightness adjustment bar K3, a trial print key K4, and a determination key K5.

In the brightness adjustment screen G3, the preview image area displays an image receiving the brightness adjustment in real time when the brightness adjustment is conducted, wherein the brightness of image can be adjusted by touching the brightness adjustment bar K3. Further, the trial print key K4 can be pressed to conduct a trial print of brightness adjusted image, and the adjustment of brightness of image can be determined by pressing the determination key K5.

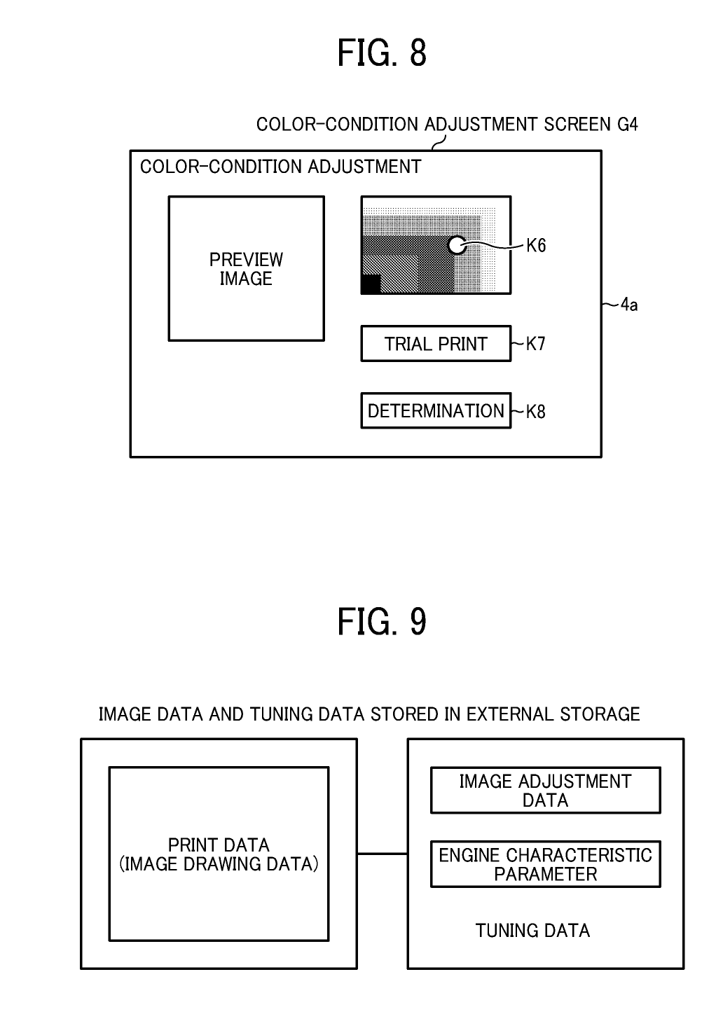

Further, when the color-condition adjustment key K2 is touched on the image adjustment menu G2, the printer control system function unit 21 shifts the image adjustment menu G2 to a color-condition adjustment screen G4 on the display area 4a of the operation panel 4 as shown in FIG. 8. For example, the color-condition adjustment screen G4 includes a preview image area, a color-condition adjustment bar K6, a trial print key K7, and a determination key K8.

In the color-condition adjustment screen G4, the preview image area displays an image receiving the color-condition adjustment in real time when the color-condition adjustment is conducted, wherein the color-condition of image can be adjusted by touching the color-condition adjustment bar K6. Further, the trial print key K7 can be pressed to conduct a trial print of color-condition adjusted image, and the adjustment of color-condition of image can be determined by pressing the determination key K8.

When the image adjustment is conducted as described above and the determination key K5 and/or the determination key K8 is operated, the printer control system function unit 21 can store an image adjustment result (i.e., adjusted image data) to a storage medium such as the HDD 15, which may be, for example, an internal storage of the image forming apparatus 1.

On one hand, when the printer control system function unit 21 stores the image adjustment result to an external storage such as the external storage 5, raw image data before receiving the image adjustment processing and tuning data including image adjustment data can be stored in the external storage 5 by linking or tying as shown in FIG. 9. The tuning data may include image adjustment data and engine characteristic parameter. The image adjustment data, which may be referred to as imaging processing information, and the engine characteristic parameter may be collectively referred to as the tuning data.

The imaging processing information used for adjusting the raw image data may be also referred to as patch data, in which the imaging processing information includes image adjustment data indicating difference between the image adjustment setting (e.g., brightness, color-condition) set via the operation panel 4, for example, by a user, and image condition of the raw image data. By applying the image adjustment data to the raw image data, print data having received with an image adjustment processing matched to a user's intension can be generated.

The engine characteristic parameter is a parameter indicating characteristics of the printer engine 3, such as red color output becomes relatively dark, which can be set by an engineer of the printer engine 3, and stored in the NVRAM 14 or the like.

Further, the external storage 5 may be a portable storage, which is detachably attachable to the external OF 19 of the image forming apparatus 1 and other image forming apparatuses. Such external storage 5 can be used with any image forming apparatuses if a particular image forming apparatus can store image data (e.g., print data) and tuning data to the external storage 5 as similar to the image forming apparatus 1.

The external storage 5 storing or holding such raw image data and tuning data can be attached to the external OF 19 of the image forming apparatus 1. Further, after storing the raw image data and tuning data to the external storage 5 using the image forming apparatus 1, the external storage 5 can be removed from the external OF 19 of the image forming apparatus 1 and then attached to other image forming apparatuses.

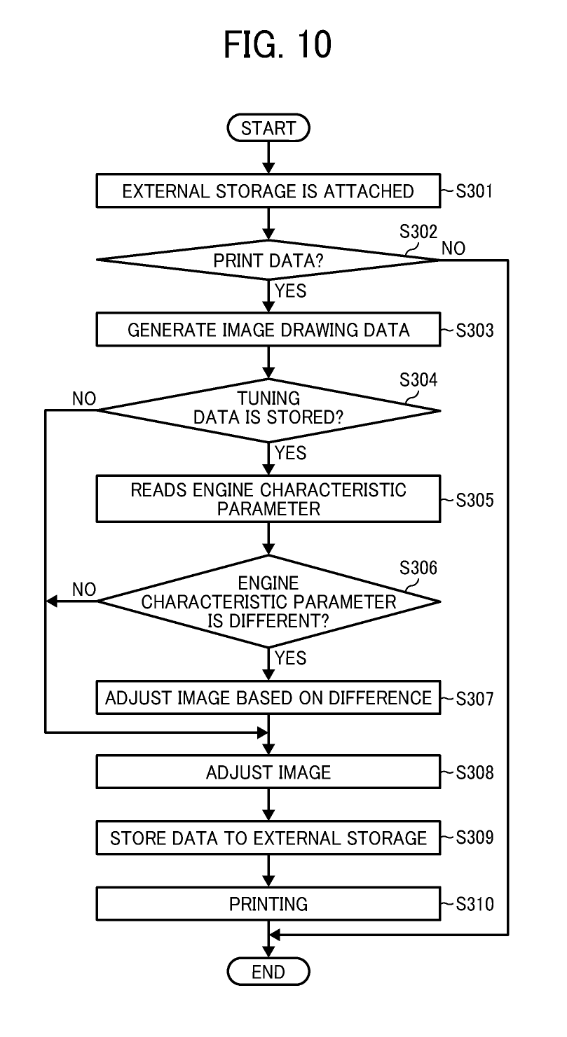

A description is given of image adjustment/printing process with reference to FIG. 10. In the following explanation, one image forming apparatus (hereinafter, first image forming apparatus) having the same function of the image forming apparatus 1 is used to store raw image data (e.g., print data) and tuning data to the external storage 5, and then such external storage 5 is attached to the external OF 19 of the image forming apparatus 1. As such, the first image forming apparatus generates and stores data, and then the image forming apparatus 1 uses the data generated by the first image forming apparatus.

Further, the image adjustment/printing process of FIG. 10 can be conducted similar manner when the image forming apparatus 1 is used to generate and store raw image data (e.g., print data) and tuning data to the external storage 5, and then the external storage 5 is attached to other image forming apparatuses.

When the external storage 5 is attached to the external OF 19 of the image forming apparatus 1 (step S301), the printer control system function unit 21 reads data from the external storage 5 via the external OF 19, and checks whether the data includes the print data such as raw image data (step S302).

If the data of the external storage 5 does not include the print data such as raw image data (step S302: No), the printer control system function unit 21 ends the image adjustment/printing processing, and a given process may be executed for the data stored in the external storage 5.

If the data of the external storage 5 includes the print data such as raw image data (step S302: Yes), the printer control system function unit 21 instructs the image analysis function unit 23 to analyze the print data, and generates or prepares data such as image drawing data based on an analysis result (step S303), and the printer control system function unit 21 checks whether the tuning data is stored in the external storage 5 (step S304).

If the tuning data is stored in the external storage 5 (step S304: Yes), the printer control system function unit 21 reads the engine characteristic parameter of the image forming apparatus 1 from the NVRAM 14 or the like (step S305). Then, the printer control system function unit 21 checks whether the engine characteristic parameter of the image forming apparatus 1 and engine characteristic parameter included in the tuning data have difference (step S306).

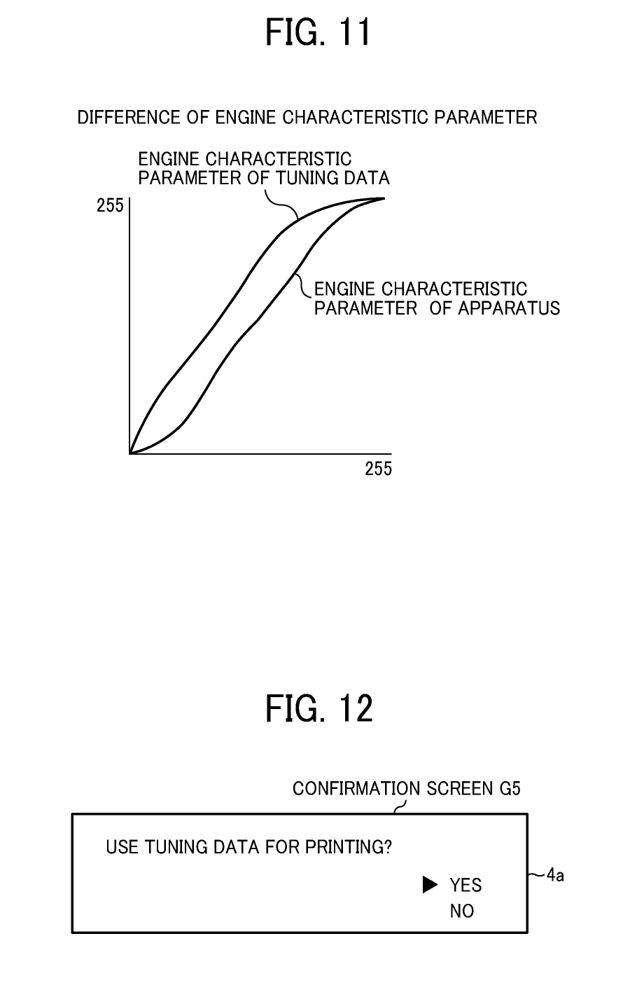

FIG. 11 shows difference of engine characteristic parameter included in the tuning data and engine characteristic parameter of the printer engine 3 of the image forming apparatus 1 that executes a printing process, wherein such engine characteristic parameter may include, for example, numerical value of color reproduction of each color such as CMYK (cyan, magenta, yellow, black), but not limited thereto.

FIG. 11 shows an example case that the engine characteristic parameter included in the tuning data and the engine characteristic parameter of the printer engine 3 of the image forming apparatus 1 that executes the printing process have difference, in which the upper profile corresponds to the engine characteristic parameter included in the tuning data, and the lower profile corresponds to the engine characteristic parameter of the printer engine 3. In FIG. 11, an area enclosed by the upper and lower profiles corresponds to the difference of the engine characteristic parameter of tuning data and the engine characteristic parameter of the printer engine 3.

Further, if the tuning data is stored in the external storage 5 (step S304: Yes), a confirmation screen G5 shown in FIG. 12 may be displayed on the display area 4a of the operation panel 4. The confirmation screen G5 displays a message whether a printing process is to be conducted using the tuning data, and if a user select “YES” for using the tuning data, a printing process using the tuning data can be conducted.

If the engine characteristic parameter of the image forming apparatus 1 and engine characteristic parameter included in the tuning data have difference (step S306: Yes), the printer control system function unit 21 executes an image adjustment processing for adjusting the difference based on the tuning data, which can be used for adjusting the difference (step S307). For example, in a case of FIG. 11, the printer control system function unit 21 conducts an image processing by adding some value corresponding to the difference to the engine characteristic parameter of the printer engine 3 (lower profile) so that the engine characteristic parameter of the printer engine 3 can be set closer to the engine characteristic parameter of the tuning data (upper profile). As such, image adjustment processing based on difference can be conducted. By conducting the image adjustment processing based on the difference, the image forming apparatus 1 can print an image with a substantially same print characteristic, printable by a printer engine of the first image forming apparatus that has conducted the image adjustment process and stored the image data to the external storage 5 before attaching the external storage 5 to the image forming apparatus 1.

As such, the printer control system function unit 21 can function as an image forming control unit. When the external storage 5 storing the print data, which may be referred to as image drawing data or raw image data, and the tuning data is attached to the storage interface of the image forming apparatus 1, the printer control system function unit 21 (image forming control unit) instructs the image analysis function unit 23 (image processing unit) to conduct an image processing to the image drawing data based on the tuning data, and instructs the printer engine 3, used as the image forming unit, to form an image based on the image drawing data processed by the image processing unit.

After step S307, the printer control system function unit 21 conducts an adjustment process, which is required for a printing process using the printer engine 3 (step S308).

Upon completing the adjustment process at step S308, the printer control system function unit 21 may store the print data such as image drawing data, which received the adjustment process to the external storage 5 via the external OF function unit 24 (step S309), and transmits the image drawing data and a print execution instruction to the printer engine 3 via the engine OF function unit 25, and instructs the printer engine 3 to execute a printing process (step S310).

If the tuning data is not stored in the external storage 5 (step S304: No) and/or if the engine characteristic parameters of different print engines have no difference (step S306: No), the process proceeds from steps S304 (or S306) to step S308, in which the printer control system function unit 21 conducts an adjustment process, which is required for a printing process using the printer engine 3 (step S308).

Upon completing the adjustment process at step S308, the printer control system function unit 21 may store the print data such as image drawing data, which received the adjustment process to the external storage 5 via the external OF function unit 24 (step S309), and transmits the image drawing data and a print execution instruction to the printer engine 3 via the engine OF function unit 25, and instructs the printer engine 3 to execute a printing process (step S310).

As described above, the image forming apparatus 1 can store the raw image data and the tuning data in the external storage 5. The tuning data can be used for processing the raw image data, wherein the tuning data includes imaging processing information designating how to conduct the processing for the raw image data.

As such, the first image forming apparatus can store the raw image data and the tuning data including imaging processing information designating a given image processing for the raw image data, which can be conducted by the first image forming apparatus, to the external storage 5. By attaching the external storage 5 to other image forming apparatus such as the image forming apparatus 1, an image processing can be conducted effectively and efficiently at the image forming apparatus 1 based on the imaging processing information designating a given image processing for the raw image data stored in the external storage 5 even if other image forming apparatus such as the image forming apparatus 1 does not have an operation panel or the like usable for setting image processing conditions.

Further, when the imaging processing information is input to the image forming apparatus 1 from the operation panel 4, the printer control system function unit 21 processes image data to generate or prepare processed image data based on the imaging processing information, and the printer control system function unit 21 displays an image corresponding to the processed image data on the display area 4a of the operation panel 4.

Therefore, a user can conduct the image adjustment processing by operating the control panel 4 while viewing a processed image or being-processed image on the display area 4a, and thereby the user can effectively and efficiently adjust the image condition matched to his or her intension.

Further, the engine characteristic parameter of the printer engine 3 of the image forming apparatus 1 can be also stored in the external storage 5 as the tuning data, wherein the image forming apparatus 1 forms image corresponding to the image data on an image recording medium such as a sheet using the printer engine 3 having a particular engine characteristic parameter. Because the image data, the imaging processing information such as image adjustment data, and the engine characteristic parameter of the printer engine 3 of the image forming apparatus 1 can be stored in the external storage 5, an image forming operation to be conducted by other image forming apparatus can be conducted in view of the difference of engine characteristic parameter of printer engine of other image forming apparatus and engine characteristic parameter of the printer engine 3 of the image forming apparatus 1 (e.g., color-condition difference). With such a configuration, produced image quality can be further enhanced.

Further, as for the image forming apparatus 1, the external storage 5 storing image data and tuning data can be attached to the external OF function unit 24. When the external storage 5 is attached to the external OF function unit 24, the printer control system function unit 21 conducts an image processing to the image data based on the tuning data. Then, based on the processed image data, the printer control system function unit 21 instructs the printer engine 3 to conduct an image forming process. Accordingly, the image data can be effectively and efficiently processed at other image forming apparatuses based on the tuning data, and an image forming can be conducted effectively and efficiently by other image forming apparatuses.

The above described configuration includes an external storage, such as a portable storage, to store image data and tuning data generated or prepared to implement good level of image forming performance at any image forming apparatus, and the above described configuration can be applied to any image processing apparatuses or image forming apparatuses such as computers, computer-combined/embedded apparatuses, copiers, printers, and multi-functional apparatuses, an image processing method, a image processing program, and storage medium.

In the above described example embodiment, image data such as raw image data and tuning data used for processing the image data can be stored in an external storage, wherein the tuning data includes imaging processing information designating how to process the image data. Further, when the imaging processing information is input, the image data can be processed based on the imaging processing information, and processed image data generated or prepared based on the imaging processing information can be displayed by a display unit. Further, engine characteristic parameter of an image forming unit that forms an image on an image recording medium using the processed image data can be also stored in the external storage as the tuning data. Further, when the external storage storing the image data and the tuning data is attached to a particular apparatus, the image data can be processed based on the tuning data, and an image forming operation can be conducted based on the processed image data at the particular apparatus.

In the above described example embodiment, imaging processing information designating how to process image data can be generated and stored in a storage medium using one image processing apparatus, and such storage medium storing the image data and imaging processing information can be effectively and efficiently used by other image processing apparatus for conducting an image processing. Such image processing apparatus may be image forming apparatuses, and the above described example embodiment can be devised as an image processing method, an image processing program, and a storage medium of the image processing program.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An image processing apparatus, comprising:
a receiving unit to receive imaging processing information indicating how to process raw image data;
a storage interface, to which an external storage device is detachably attachable, to access data stored in the external storage device; and
a storage controller to store the raw image data and the imaging processing information to the external storage,
wherein the raw image data is data unprocessed by an image processing operation conductable using the imaging processing information used as tuning data for processing the raw image data.

2. The image processing apparatus of claim 1, further comprising:
an input unit to input the imaging processing information;
a display unit to display an image;
an image processing unit to process the raw image data based on the imaging processing information, and to generate processed image data; and
an image processing control unit to instruct the image processing unit to conduct image processing of the raw image data based on the imaging processing information input by the input unit, and to display an image corresponding to the processed image data on the display unit.

3. An image forming apparatus, comprising:
an image processing unit to process raw image data based on imaging processing information designating how to process the raw image data, and to generate processed image data;
a storage interface, to which an external storage device is detachably attachable, to access data in the external storage device;
an image forming unit, having a given engine characteristic for forming images, to form an image on a recording medium based on the processed image data; and
a storage controller to store the raw image data and the imaging processing information to the external storage device,
wherein the raw image data is unprocessed by an image processing operation conductable using the imaging processing information used as tuning data for processing the raw image data.

4. The image forming apparatus of claim 3, further comprising:
an input unit to input the imaging processing information;
a display unit to display an image; and
an image processing control unit to instruct the image processing unit to conduct image processing of the raw image data based on the imaging processing information input by the input unit, and to display an image corresponding to the processed image data on the display unit.

5. The image forming apparatus of claim 3, wherein the storage controller stores the imaging processing information and parameters of the engine characteristic as the tuning data to the external storage device.

6. The image forming apparatus of claim 3, further comprising an image forming control unit,
wherein when the external storage device storing the raw image data and the tuning data is attached to the storage interface, the image forming control unit instructs the image processing unit to conduct image processing of the raw image data based on the tuning data, and instructs the image forming unit to from an image based on the raw image data processed by the image processing unit.

7. The image forming apparatus of claim 6, wherein when parameters of the engine characteristic are stored in the external storage device as the tuning data and then the external storage device storing the raw image data and the tuning data is attached to the storage interface, the image forming control unit instructs the image processing unit to conduct image processing of the raw image data based on a comparison of the engine characteristic parameters stored in the external storage device and engine characteristic parameters of the image forming unit of the image forming apparatus.

8. A non-transitory computer readable carrier medium storing a program that, when executed by a computer, causes the computer to execute a method of controlling image processing by an image forming apparatus, the method comprising the steps of:
receiving imaging processing information indicating how to process raw image data;
accessing data in an external storage device detachably attachable to the image forming apparatus; and
storing the raw image data and the imaging processing information to the external storage device,
wherein the raw image data is data unprocessed by an image processing operation conductable using the imaging processing information used as tuning data for processing the raw image data.

9. The non-transitory computer readable carrier medium of claim 8, wherein the method further comprises the steps of:
processing the raw image data based on the imaging processing information indicating how to process the raw image data,
generating processed image data; and
forming an image on a recording medium based on the processed image data using the image forming apparatus having a given engine characteristic for forming images.
